(19) United States
(12) Patent Application Publication
(10) Pub. No.: US 2016/0299312 A1
(43) Pub. Date: Oct. 13, 2016

(54) LENS DRIVING DEVICE

(71) Applicant: SAMSUNG ELECTRO-MECHANICS CO., LTD., Suwon-si (KR)

(72) Inventor: Yong Wan CHO, Suwon-si (KR)

(73) Assignee: SAMSUNG ELECTRO-MECHANICS CO., LTD., Suwon-si (KR)

(21) Appl. No.: 14/993,631

(22) Filed: Jan. 12, 2016

(30) Foreign Application Priority Data
Apr. 8, 2015 (KR) 10-2015-0049819

(51) Int. Cl. G02B 7/08; G02B 27/64

(52) U.S. Cl. CPC G02B 7/08; G02B 27/646

(57) ABSTRACT

A lens driving device includes a housing; a lens barrel disposed in the housing so as to support comprising a lens; and a location adjustment unit providing configured to apply a force for rotation of to the lens barrel and guiding to guide a rotation of the lens barrel.

### CROSS-REFERENCE TO RELATED APPLICATION

This application claims the benefit under 35 USC 119(a) of Korean Patent Application No. 10-2015-0049819 filed on Apr. 8, 2015, with the Korean Intellectual Property Office, the entire disclosure of which is incorporated herein by reference for all purposes.

### BACKGROUND

1. Field

The present disclosure relates to a lens driving device.

2. Description of Related Art

Recently, along with development of highly functionalized and miniaturized camera modules, camera modules have been commonly applied to mobile devices such as portable phones, laptop computers, and tablet PCs. Generally, camera modules include an optical system including a lens, an auto-focusing device for adjusting a focal point by moving the optical system with respect to an optical axis, an image sensor (e.g., CMOS and CCD) for converting an object into an electrical signal, and so on.

In addition, in order to overcome the inconvenience of viewing blurred images due to the shaking of a photographer's hand when an image or video is taken, camera modules frequently further include a device to compensate for handshake (e.g., optical image stabilization (OIS)). However, in such a conventional camera module, the auto-focusing device and the hand-shaking compensation device have complex structures, require a plurality of components, and are of increased size, and thus a miniaturized and lightweight camera module is difficult to achieve.

Accordingly, research into a lens driving device that may overcome the aforementioned issue is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens driving device that is lightweight and miniaturized while having auto-focusing and handshake correction functions. The lens driving device includes a housing; a lens barrel disposed in the housing so as to support comprising a lens; and a location adjustment unit providing configured to apply a force for rotation of to the lens barrel and guiding to guide a rotation of the lens barrel.

In another general aspect, a lens driving device includes a housing; a lens barrel disposed in the housing so as to configured to support a lens; and a location adjustment unit that configured to rotates the lens barrel on a part of the lens barrel except for a part, through which the lens is exposed, so as to restore the lens to an optical axis location

The location adjustment unit includes a driver disposed in the housing and the lens barrel and configured to provide a force for moving one side of the lens barrel to the optical axis direction, and a barrel guider disposed between the housing and the lens barrel, guiding rotation of the lens barrel during rotation of the lens barrel with respect to a tilting axis perpendicular to a direction of an optical axis, and guiding movement of the lens barrel during movement in the direction of the optical axis.

The barrel guider includes a ring guide member coupled to an outer circumferential surface of the lens barrel and a link member having an external side surface that contacts the housing and is guided to move in the direction of the optical axis in the housing and an inner side surface that contacts the ring guide member and guides rotation of the ring guide member about a tilting axis.

The link member includes a link frame formed in a shape corresponding to an internal shape of the housing and a plate spring having a central portion that is concave to protrude toward the ring guide member so as to contact a convex curved external side surface of the ring guide member. At least three plate springs are spaced apart from each other in the link frame by an equivalent interval.

The link frame includes a guide protrusion protruding toward the housing in a longitudinal shape in a direction of an optical axis.

The housing includes a base member, and a contact member coupled to the base member and disposed to contact the guide protrusion to slide.

The driver includes a magnet member disposed on an outer circumference surface of the lens barrel and a coil member disposed on an internal side surface of the housing so as to be opposite to the magnet member.

The location adjustment unit further includes a controller that is electrically connected to the coil member and controls driving of the driver.

Other features and aspects will be apparent from the following detailed description, the drawings, and the claims.

### BRIEF DESCRIPTION OF DRAWINGS

FIG. 1 is a perspective view illustrating a lens driving device according to an embodiment;

FIG. 2 is an exploded perspective view of the lens driving device of FIG. 1;

FIG. 3 is a perspective view of a lens driving device of FIG. 1 without a housing;

FIG. 4 is a partial perspective view of the lens driving device of FIG. 1;

FIG. 5 is a perspective view of a driver for a lens driving device;

FIG. 6 is a perspective view of a link frame of a lens driving device;

FIG. 7 is a perspective view of a ring guide member of a lens driving device; and

FIG. 8 is a table showing a driving state of a lens driving device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the disclosure.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

The terminology used herein is for describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

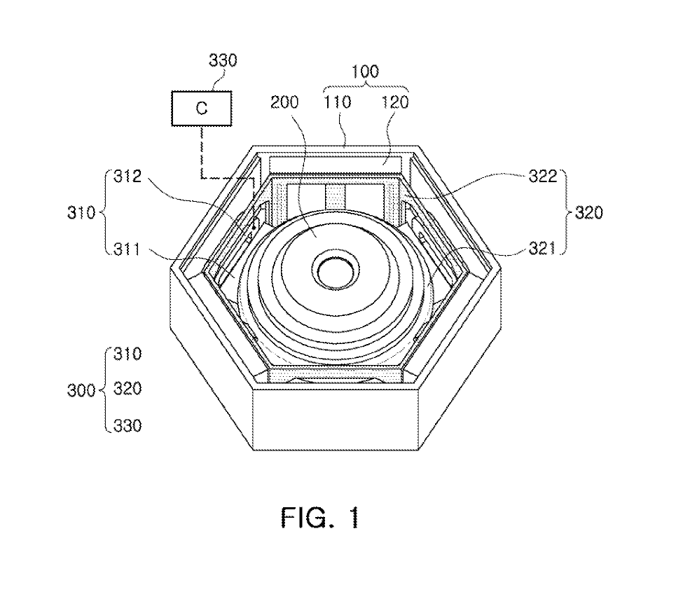

Referring to FIG. 1, a lens driving device moves a lens barrel 200 to automatically adjust a focal point and to prevent hand shaking. That is, the lens driving device advantageously incorporates an auto-focusing function and handshake prevention function, and in particular, has both the auto-focusing function and handshake prevention function while being miniature and light weight. Due to a reduced number of components in comparison to a conventional lens driving device, the manufacturing costs are reduced.

In addition, a power supply for driving a lens may be coupled to a fixed housing 100 rather than being coupled to a structure of a moveable lens barrel, and thus short circuits are prevented by the lens driving device.

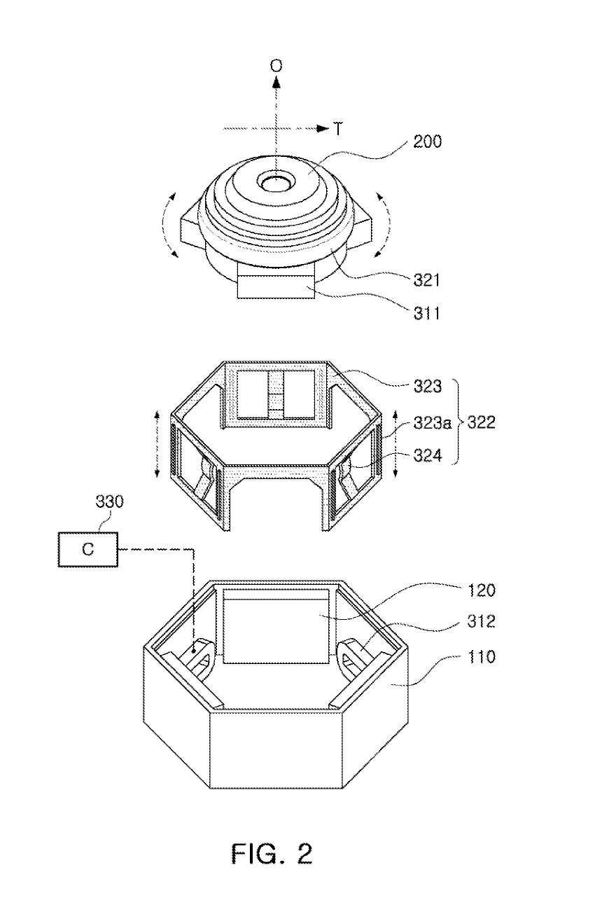

Referring to FIGS. 1 and 2, the lens driving device includes the housing 100, a lens barrel 200 positioned in the housing 100 so as to support the lens, and a location adjustment unit 300 disposed between the housing 100 and the lens barrel 200 to provide force for rotation of the lens barrel 200 with respect to a tilting axis T perpendicular to a direction of an optical axis O, and to guide rotation of the lens barrel 200.

In other words, the lens driving device includes the housing 100, the lens barrel 200 positioned in the housing 100 so as to support a lens, and the location adjustment unit 300 that rotates the lens barrel 200 with respect to a part of the lens barrel 200 except for a part through which the lens is exposed, so as to restore the lens to an optical axis location.

The housing 100 of the lens driving device includes a base member 110 and a contact member 120, coupled to the base member 110, contacting a guide protrusion 323a. When the location adjustment unit 300 applies power to the lens barrel 200 to move the lens barrel 200 in a direction along the optical axis O, an auto-focusing function is performed, and when the location adjustment unit 300 moves the lens barrel 200 along a plane perpendicular to the optical axis O, a handshake prevention (e.g., optical image stabilization (OIS)) function is performed.

The housing 100 supports and includes the lens barrel 200, the location adjustment unit 300, and so on, which will be described later, and may be included as a part of a camera module. To this end, the housing 100 includes the base member 110 and the contact member 120. Here, the contact member 120 is a contact member for guiding a link frame 323 of the location adjustment unit 300, to be described later, while being moved along a direction of the optical axis O.

The lens barrel 200 supports a lens or a group of lenses, and is included in the housing 100. In addition, the lens barrel 200 is capable of being moved along a plane perpendicular to the optical axis O or the direction of the optical axis O by the location adjustment unit 300, to be described later, to perform the auto-focusing or handshake prevention function.

The location adjustment unit 300 performs the auto-focusing function by applying force for rotation of the lens barrel 200 with respect to the tilting axis T to move the lens barrel 200 in the direction of the optical axis O, or perform the handshake prevention function by moving the lens barrel 200 along a plane perpendicular to the direction of the optical axis O. In particular, the location adjustment unit 300 may apply the force for rotation with respect to the tilting axis T at one point or a plurality of points.

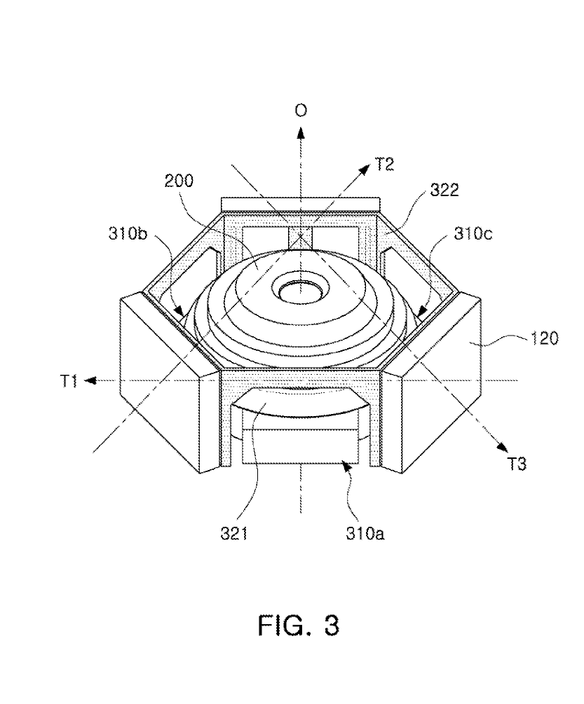

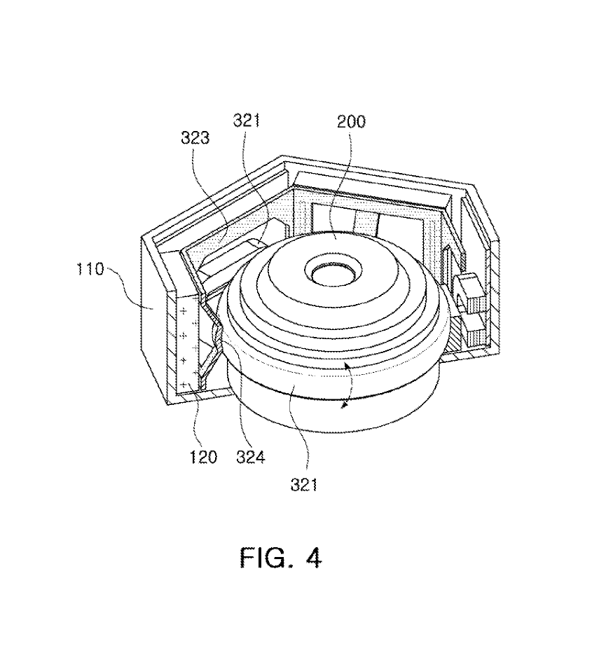

In addition, the location adjustment unit 300 applies the force for rotation of the lens barrel 200 to the lens barrel 200, and simultaneously guides the rotation of the lens barrel 200 in a predetermined direction so as to move the lens barrel 200 in the direction of the optical axis O or along a plane perpendicular to the optical axis O. To this end, the location adjustment unit 300 includes a driver 310, a barrel guider 320, and a controller 330, which will be described below in detail with reference to FIGS. 3 through 8.

Referring to FIGS. 3, 4, and 8, the location adjustment unit 300 of the lens driving device includes the driver 310 disposed to be associated with the housing 100 and the lens barrel 200 and providing force for moving one side of the lens barrel 200 in the direction of the optical axis O, and the barrel guider 320 disposed between the housing 100 and the lens barrel 200 guiding rotation of the lens barrel 200 during rotation of the lens barrel 200 with respect to the tilting axis T, and guiding movement of the lens barrel 200 during movement of the lens barrel 200 in the direction of the optical axis O.

In addition, the barrel guider 320 of the lens driving includes a ring guide member 321 coupled to an outer circumference surface of the lens barrel 200, and a link member 322 having an external side surface that contacts the housing 100 and is guided to move in the direction of the optical axis O in the housing 100 and an inner side surface that contacts the ring guide member 321 and guides rotation of the ring guide member 321 with respect to the tilting axis T.

In addition, the location adjustment unit 300 of the lens driving device further includes the controller 330 electrically connected to a coil member 312 and adjusting driving of the driver 310. That is, the location adjustment unit 300 includes the driver 310, the barrel guider 320, and the controller 330 and performs the auto-focusing function by applying force for rotation of the lens barrel 200 with respect to the tilting axis T to move the lens barrel 200 in the direction of the optical axis O or perform the handshake prevention function by moving the lens barrel 200 along a plane perpendicular to the direction of the optical axis O.

The driver 310 provides a force for pushing or pulling the lens barrel 200 in the direction of the optical axis O, and in particular, the driver 310 may be provided on one side of the lens barrel 200 creating a force imbalance, causing rotation of the lens barrel 200 about the tilting axis T. The lens barrel 200 is guided by the barrel guider 320, to be described later, to move along the optical axis O.

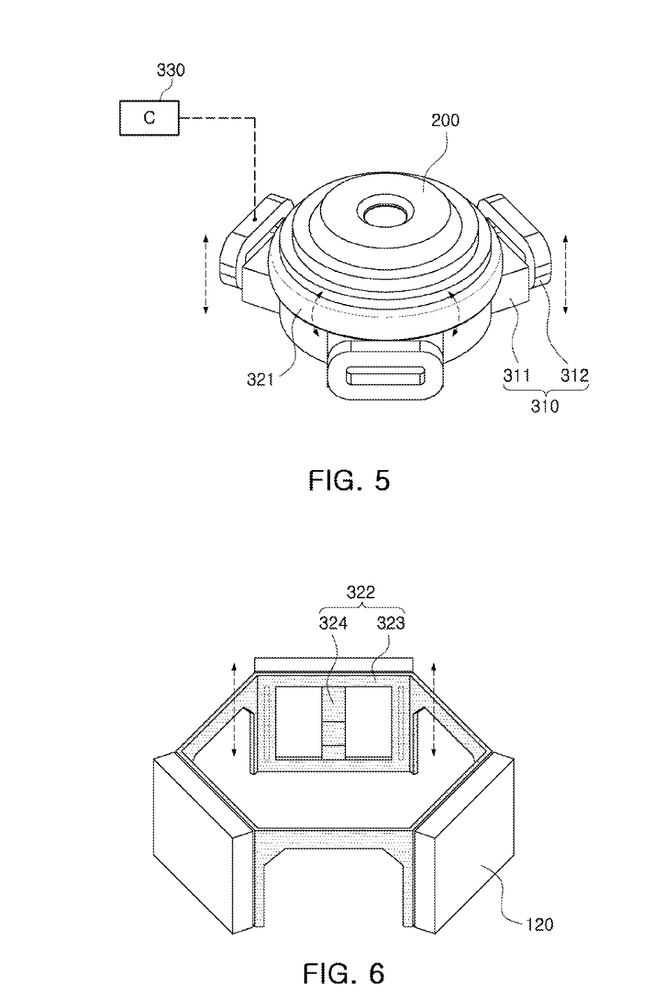

In addition, a plurality of drivers 310 may be provided in the lens barrel 200. As such, the plurality of drivers 310 combine forces applied to the lens barrel 200 and move the lens barrel 200 in the direction of the optical axis O to perform auto-focusing or move the lens barrel 200 along a plane perpendicular to the optical axis O to perform handshake prevention. To this end, the driver 310 includes a magnet member 311 and the coil member 312, which will be described below in detail with reference to FIG. 5.

The barrel guider 320 converts force directed in the direction of the optical axis O, which is provided to the lens barrel 200 by the driver 310, into force for rotation driving about the tilting axis T, or may guide movement of the lens barrel 200 in the direction of the optical axis O. To this end, the barrel guider 320 is disposed between the housing 100 and the lens barrel 200 and includes the ring guide member 321 and the link member 322. The ring guide member 321 guides rotation of the lens barrel 200 about the tilting axis T in cooperation with the link member 322. That is, when the driver 310 applies force to one side of the lens barrel 200 in the direction of the optical axis O, the ring guide member 321 converts the force into a force for rotation of the lens barrel 200 with about the tilting axis T in cooperation with the link member 322. To this end, the ring guide member 321 may be formed in a ring shape so as to be coupled to the lens barrel 200, and may have an external side surface formed in a convex curved surface shape for cooperation with the link member 322. That is, the ring guide member 321 rotates the lens barrel 200 using the same principle as that of a ball bearing because an external side surface of the ring guide member 321 is formed in a convex curved surface shape.

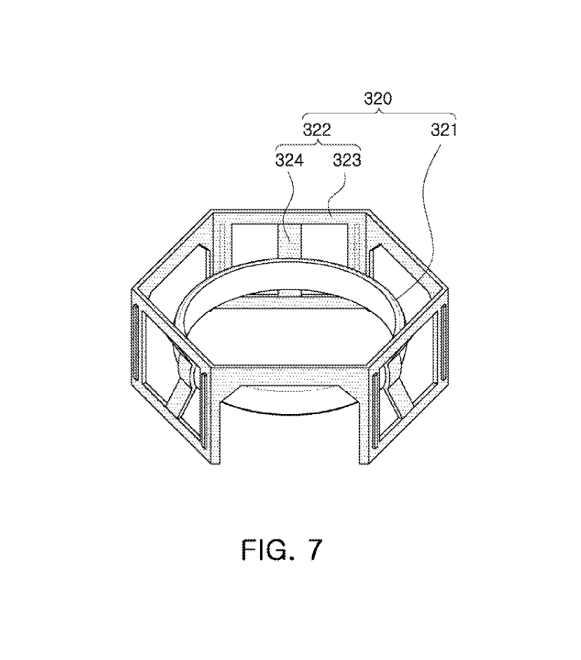

The link member 322 rotates the lens barrel 200 about the tilting axis T in cooperation with the ring guide member 321, and simultaneously guides the lens barrel 200 to move along the optical axis O. To this end, the link member 322 is disposed between the housing 100 and the ring guide member 321, and includes the link frame 323 and a plate spring 324, which will be described below in detail with reference to FIGS. 6 and 7.

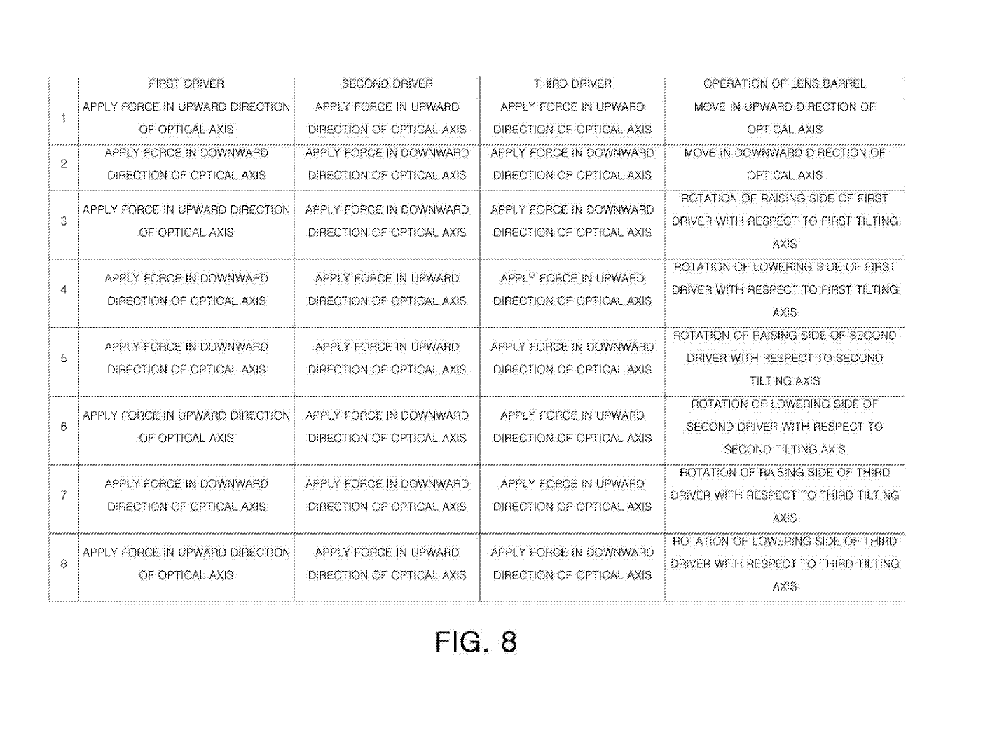

For example, the auto-focusing function performed by moving the lens barrel 200 along the optical axis O and the handshake prevention function performed by moving the lens barrel 200 along a plane perpendicular to the direction of the optical axis O by the driver 310 and the barrel guider 320 will be described with reference to FIG. 8.

Three drivers 310 are disposed in three divided locations with respect to the lens barrel 200. That is, the three drivers 310 include a first driver 310a, a second driver 310b, and a third driver 310c (See FIG. 3).

The auto-focusing function is performed by the drivers 310a-310c applying a force to the barrel lens 200. When the first driver 310a, the second driver 310b, and the third driver 310c apply force for moving the lens barrel 200 in an upward direction of the optical axis O, the resultant force from the three drivers 310a-310c are applied in the upward direction of the optical axis O so as to move the lens barrel 200 upward (First Embodiment). In addition, when the first driver 310a, the second driver 310b, and the third driver 310c apply force for moving the lens barrel 200 in a downward direction of the optical axis O, the resultant force from the three drivers 310a-310c applied in the downward direction of the optical axis O so as to move the lens barrel 200 downward (Second Embodiment). Accordingly, an auto-focusing function of automatically adjusting a focal point by moving the lens barrel 200 upward or downward is achieved.

During the handshake prevention function, the lens barrel 200 is driven along a plane perpendicular to the optical axis O. In particular, movement of the lens barrel 200 on a plane perpendicular to the optical axis O so as to be inclined to the first driver 310a will be described. That is, when the first driver 310a applies force for moving the lens barrel 200 in an upward direction of the optical axis O, and the second driver 310b and the third driver 310c apply force for moving the lens barrel 200 in a downward direction of the optical axis O, the resultant force of the three forces are inclined to the first driver 310a and rotate the lens barrel 200 about a first tilting axis T1 positioned in parallel to a segment connecting the second driver 310b and the third driver 310c (See FIG. 3). In detail, a part of the lens barrel 200, in which the first driver 310a is positioned, moves in an upward direction with respect to the optical axis O. Accordingly, a lens positioned in a central part of the lens barrel 200 is moved in the direction toward the first driver 310a on a plane perpendicular to the optical axis O to perform handshake compensation (Third Embodiment). In other words, the lens barrel rotates about the first tilting axis T1, causing the center the lens to move closer to the first driver 310a.

In addition, when the first driver 310a applies a force for moving the lens barrel 200 in a downward direction of the optical axis O, and the second driver 310b and the third driver 310c apply force for moving the lens barrel 200 in an upward direction of the optical axis O. The resultant force of the three forces is inclined to the first driver 310a, and moves the lens barrel 200 about the first tilting axis T1. In detail, a part of the lens barrel 200, in which the first driver 310a is positioned, moves in a downward direction with respect to the optical axis O. Accordingly, a lens positioned in a central part of the lens barrel 200 is moved in the direction toward the first driver 310a on a plane perpendicular to the optical axis O to perform handshake compensation (Fourth Embodiment). In other words, the lens barrel rotates about the first tilting axis T1, causing the center the lens to move closer to the first driver 310a.

Next, movement of the lens barrel 200 on a plane perpendicular to the optical axis O so as to be inclined to the second driver 310b will be described. When the second driver 310b applies force for moving the lens barrel 200 in an upward direction of the optical axis O, and the first driver 310a and the third driver 310c apply forces for moving the lens barrel 200 in a downward direction of the optical axis O, the resultant force of the three forces is inclined to the second driver 310b, and moves the lens barrel 200 with respect to a second tilting axis T2 positioned in parallel to a line segment connecting the first driver 310a and the third driver 310c. In detail, a part of the lens barrel 200, in which the second driver 310b is positioned, moves in an upward direction with respect to the optical axis O. Accordingly, a lens positioned in a central part of the lens barrel 200 is moved in the direction toward the second driver 310b on a plane perpendicular to the optical axis O to perform handshake compensation (Fifth Embodiment). In other words, the lens barrel rotates about the second tilting axis T2, causing the center the lens to move closer to the second driver 310b.

In addition, when the second driver 310b applies force for moving the lens barrel 200 in a downward direction of the optical axis O, and the first driver 310a and the third driver 310c apply force for moving the lens barrel 200 in an upward direction of the optical axis O, the resultant force of the three forces is inclined to the second driver 310b and rotates the lens barrel 200 about the second tilting axis T2. In detail, a part of the lens barrel 200, in which the second driver 310b is positioned, moves in a downward direction with respect to the optical axis O. Accordingly, a lens positioned in a central part of the lens barrel 200 moves toward the second driver 310b along a plane perpendicular to the optical axis O to perform handshake compensation (Sixth Embodiment). In other words, the lens barrel rotates about the second tilting axis T2, causing the center the lens to move closer to the second driver 310b.

The handshake prevention function, wherein movement of the lens barrel 200 on a plane perpendicular to the optical axis O so as to be inclined to the third driver 310c will be described. When the third driver 310c applies force for moving the lens barrel 200 in an upward direction of the optical axis O, and the second driver 310b and the first driver 310a apply forces for moving the lens barrel 200 in a downward direction of the optical axis O, the resultant force of the three forces is inclined to the third driver 310c, and rotates the lens barrel 200 about a third tilting axis T3 positioned in parallel to a line segment connecting the second driver 310b and the first driver 310a. A part of the lens barrel 200, in which the third driver 310c is positioned, moves in an upward direction with respect to the optical axis O. Accordingly, a lens positioned in a central part of the lens barrel 200 is moved in the direction toward the third driver 310c on a plane perpendicular to the optical axis O to perform handshake compensation (Seventh Embodiment). In other words, the lens barrel rotates about the third tilting axis T3, causing the center the lens to move closer to the third driver 310c.

In addition, when the third driver 310c applies force for moving the lens barrel 200 in a downward direction of the optical axis O, and the second driver 310b and the first driver 310a apply forces for moving the lens barrel 200 in an upward direction of the optical axis O, the resultant force of the three forces is inclined to the third driver 310c and rotates the lens barrel 200 with respect to the third tilting axis T3. A part of the lens barrel 200, in which the third driver 310c is positioned, moves in a downward direction with respect to the optical axis O. Accordingly, a lens positioned in a central part of the lens barrel 200 is moved in the direction toward the third driver 310c on a plane perpendicular to the optical axis O to perform handshake compensation (Eight Embodiment). In other words, the lens barrel rotates about the third tilting axis T3, causing the center the lens to move closer to the third driver 310c.

According to a combinational operation of the first to eighth embodiments, the auto-focusing function and the handshake prevention function may be performed in all directions.

Referring to FIG. 5, the driver 310 of the lens driving device includes the magnet member 311 disposed on an outer circumference surface of the lens barrel 200 and the coil member 312 disposed on an internal side surface of the housing 100 so as to face the magnet member 311. The driver 310 of the lens driving device includes at least three drivers 310a-310c that are spaced apart from each other by an equivalent interval in the housing 100. The magnet member 311 and the coil member 312 are provided in order to apply force to the lens barrel 200 in the direction of the optical axis O. The magnet member 311 is a permanent magnet for generation of a magnetic field, and is coupled to the outer circumference surface of the lens barrel 200. In particular, in order to prevent interference with the ring guide member 321, the magnet member 311 is coupled to the outer circumference surface of the lens barrel 200, except for a portion to which the ring guide member 321 is coupled.

In addition, the coil member 312 generates electromagnetic force (Lorentz's force) according to supplied current. The coil member 312 is coupled to an internal side surface of the housing 100 and positioned at an opposite location to the magnet member 311. In particular, the coil member 312 is disposed in the fixed housing 100 rather than being disposed in the lens barrel 200 that generates movement so as to provide stable driving force and prevent short circuits during connection with an external power source. That is, when a coil, to which current is supplied, is disposed on the moving lens barrel 200, the coil member 312, which are coupled to an external power source, may be damaged due to accumulated fatigue stress according to frequent movement, resulting in short circuits. However, according to the embodiments, this issue is prevented.

In addition, the drivers 310 smoothly move the lens barrel along a plane perpendicular to the optical axis O, through the electromagnetic force between the combined magnet member 311 and coil member 312. A minimum number of drivers 310, and for example, three drivers 310 may be spaced apart from each other by an equivalent interval with respect to the lens barrel 200 or the housing 100.

Referring to FIGS. 6 and 7, the link member 322 of the lens driving device includes the link frame 323 formed in a shape corresponding to an internal shape of the housing 100 and accommodated in the housing 100. The plate spring 324 has a central portion that is concave to protrude toward the ring guide member 321 so as to contact a convex curved external side surface of the ring guide member 321 and opposite ends coupled to the link frame 323.

At least three plate springs 324 of the lens driving device are spaced apart from each other by an equivalent interval in the link frame 323. The link frame 323 of the lens driving device includes the guide protrusion 323a that is formed to protrude toward the housing 100 so as to have a longitudinal shape in the direction of the optical axis O. The link frame 323 of the lens driving device provides an empty space for accommodating the driver 310 in order to prevent interference with the driver 310.That is, the link member 322 includes the link frame 323 and the plate spring 324 in order to support the lens barrel 200 as it rotates about the tilting axis T in cooperation with the ring guide member 321, and to guide movement of the lens barrel 200 in the direction of the optical axis O.

The link frame 323 comprises a body of the link member 322 and is disposed between the housing 100 and the lens barrel 200. To this end, the link frame 323 may be formed in a shape corresponding to an internal shape of the housing 100. In particular, the link frame 323 includes the guide protrusion 323a that contacts the internal side surface of the housing 100. That is, the link frame 323 includes the guide protrusion 323a in order to minimize friction with the housing 100. As described above, the contact member 120 is disposed on the internal side surface of the housing 100, which contacts the guide protrusion 323a of the link frame 323. In addition, the guide protrusion 323a protrudes toward the housing 100 in order to reduce a contact area with the contact member 120.

For example, when the lens barrel 200 moves along the optical axis O during auto-focusing, the contact member 120 and link frame 323 generate friction, and thus the guide protrusion 323a is formed in a longitudinal shape with respect to the direction of the optical axis O to guide the lens barrel 200.

In addition, the link frame 323 is disposed between the housing 100 and the lens barrel 200, and thus interference with the driver 310 may occur. In order to prevent the interference, the link frame 323 has an empty space for accommodating the driver 310. In other words, the link frame 323 comprises a plurality of lateral sides and is configured to accommodate the lens barrel and driver 310. For example, the plurality of lateral sides have opening corresponding to the drivers 310 so as to prevent interference. The top and bottom of the link frame 323 are open.

The plate spring 324 is connected to the lens barrel 200, and in detail, guides rotation of the lens barrel 200 about the tilting axis T in cooperation with the ring guide member 321 coupled to the outer circumference surface of the lens barrel 200. That is, the plate spring 324 has a central portion that is concave to correspond to a convex curved external side surface of the ring guide member 321, and opposite end portions coupled to the link frame 323. In addition, the central portion protrudes toward the ring guide member 321 so as to elastically support the ring guide member 321.

In particular, the plate spring 324 is elastic, and thus the plate spring 324 provides force for restoring the lens barrel 200 after being rotated about the tilting axis T. In addition, a plurality of plate springs 324 may be disposed at three points that are spaced apart by an equivalent interval with respect to the lens barrel 200 in order to stably support and guide the lens barrel 200.

As set forth above, the lens driving device is advantageous in performing the auto-focusing and handshake prevention functions. In particular, the lens driving device has both the auto-focusing and handshake prevention functions while being lightweight and miniaturized. In addition, the number of components may be reduced compared to a conventional lens driving device. In addition, a power supply for driving a lens may be coupled to a fixed housing rather than being coupled to a moveable lens barrel, and thus the lens driving device is advantageous in preventing an issue in terms of short circuits.

The apparatuses, units, modules, devices, and other components illustrated in FIGS. 1-7 that perform the operations described herein with respect to FIG. 8 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 8. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 8 that perform the operations described herein are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving device comprising:
a housing;
a lens barrel disposed in the housing comprising a lens; and
a location adjustment unit configured to apply a force to the lens barrel and to guide a rotation of the lens barrel.

2. The lens driving device of claim 1, wherein the location adjustment unit comprises a barrel guider, disposed between the housing and the lens barrel, configured to:
guide rotation of the lens barrel during rotation of the lens barrel about a tilting axis perpendicular to an optical axis, and
guide movement of the lens barrel along the optical axis.

3. The lens driving device of claim 2, wherein the barrel guider comprises a ring guide member coupled to an outer circumferential surface of the lens barrel.

4. The lens driving device of claim 3, wherein the barrel guider further comprises a link member comprising an external side surface in contact with the housing, and an inner side surface in contact with the ring guide member,
wherein the link member is configured to move along the optical axis guided by the housing, and the ring guide member guides rotation of the ring guide member about a tilting axis.

5. The lens driving device of claim 4, wherein the link member comprises a plate spring comprises a concave central portion that extends to a convex curved external side surface of the ring guide member.

6. The lens driving device of claim 4, wherein the link member further comprises a link frame comprising a shape corresponding to an internal shape of the housing, wherein the link frame is accommodated in the housing, and coupled to opposite ends of the plate spring.

7. The lens driving device of claim 6, wherein three plate springs are spaced apart from each other in the link frame by an equivalent interval.

8. The lens driving device of claim 6, wherein the link frame comprises a guide protrusion protruding toward the housing, and extending in the optical axis.

9. The lens driving device of claim 8, wherein the housing comprises:
a base member; and
a contact member coupled to the base member and disposed to contact the guide protrusion, wherein the guide protrusion is configured to slide along the contact member.

10. The lens driving device of claim 1, wherein the location adjustment unit further comprises a driver disposed in the housing and the lens barrel, and configured to provide force for moving one side of the lens barrel along a direction of an optical axis.

11. The lens driving device of claim 10, wherein the driver comprises a magnet member disposed on an outer circumference surface of the lens barrel.

12. The lens driving device of claim 10, wherein the driver further comprises a coil member disposed on an internal side surface of the housing so as to face the magnet member.

13. The lens driving device of claim 12, wherein the at least three drivers are spaced apart from each other in the housing by an equal interval.

14. The lens driving device of claim 12, wherein in the link frame is configured to accommodate the driver in an empty space in order to prevent interference with the driver.

15. The lens driving device of claim 12, wherein the location adjustment unit further comprises a controller that is electrically connected to the coil member and controls driving of the driver.

16. A lens driving device comprising:
a housing;
a lens barrel disposed in the housing configured to support a lens; and
a location adjustment unit configured to rotate the lens barrel so as to restore the lens to an optical axis location.
